(19) United States
(12) Patent Application Publication
(10) Pub. No.: US 2006/0231640 A1
(43) Pub. Date: Oct. 19, 2006

(54) Waste heat utilizing system

(75) Inventors: Nobuyuki Hashimura, Tokai-city (JP); Yoshio Miyata, Nagoya-city (JP); Shinji Ogawa, Nagoya-city (JP); Yusuke Yanagisawa, Chiryu-city (JP); Takashi Toyoshima, Obu-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/405,606

(22) Filed: Apr. 17, 2006

(30) Foreign Application Priority Data
Apr. 18, 2005 (JP) 2005-119581
Feb. 1, 2006 (JP) 2006-024288

(51) Int. Cl. B60H 1/22

(52) U.S. Cl. 237/34

(57) ABSTRACT

A main cooling circuit is formed by an engine, a radiator and a first pump. A hot water circuit is formed by the engine, a heater core and the first pump. A heat storing water circuit is connected between a bifurcating point of the hot water circuit and the engine, wherein a second pump and a heat storage tank are provided in the heat storing water circuit. Engine cooling water stored in the heat storage tank is circulated by the second pump, so that the hot water is supplied to the engine before the engine operation is started. The engine cooling water is also circulated by the second pump during the engine operation, so that hot water is stored in the heat storage tank.

### CROSS REFERENCE TO RELATED APPLICATION

This application is based on Japanese Patent Application Nos. 2005-119581 filed on Apr. 18, 2005, and 2006-24288 filed on Feb. 1, 2006, the disclosures of which are incorporated herein by reference.

### FIELD OF THE INVENTION

The present invention relates to a waste heat utilizing system for an automotive engine for facilitating a warming-up operation of a water cool internal combustion engine, and more particularly relates to a waste heat utilizing system for an automotive engine having a hot water storage tank for an engine cooling water.

### BACKGROUND OF THE INVENTION

A waste heat utilizing system for a water cool internal combustion engine is known in the art, in which high temperature engine cooling water (hot water) circulating in an engine cooling circuit is stored in a hot water tank, the stored hot water is supplied to the engine by an electrical pump shortly before starting an engine operation in the next time in order to facilitate a warming-up operation of the engine, and the high temperature engine cooling water is supplied to a heater core to perform a heating operation for a vehicle passenger room after the engine has been warmed up.

According to the above conventional waste heat utilizing system, however, the water temperature stored in the tank may become lower than that of the engine cooling water at starting the engine operation, for example, when the engine has not been operated for a long period. In such a situation, there is a problem that the temperature increase of the engine cooling water is prevented by the hot water storage tank, if the engine cooling water is circulated into and through the hot water storage tank.

Accordingly, it is proposed in the art (for example, Japanese Patent Publication No. H10-71838) that the fluid flow of the engine cooling water is switched over by a three-way valve having three inlet/outlet ports so that the engine cooling water bypasses the hot water storage tank, when the circulation of the engine cooling water through the tank is not desired.

However, such a system has a disadvantage that the cost thereof becomes high due to the three-way valve.

### SUMMARY OF THE INVENTION

The present invention is made, therefore, in view of the foregoing problem, and has an object to provide a waste heat utilizing system, which is low in cost by eliminating a three-way valve.

It is another object of the present invention to provide a hot water storage tank, which can be applied to the waste heat utilizing system for an automotive engine.

It is a further object of the present invention to provide a waste heat utilizing system, in which an operating rate of an electrical pump is reduced to suppress consumption of electric power.

According to a feature of the present invention, a waste heat utilizing system for an automotive vehicle having a water cool internal combustion engine (1) comprises; a heater core (7d) for performing heat exchange between engine cooling water flowing out of the engine (1) and air to be blown into a vehicle passenger room; a first fluid passage (8) for connecting the heater core (7d) with the engine (1) to form a closed fluid circuit, through which the engine cooling water flows from the engine (1) to the heater core (7d); a heat storage tank (12) for storing the engine cooling water and keeping the heat thereof; and a second fluid passage (10) bifurcated from a bifurcating point (8a) of the first fluid passage (8) at a downstream side of the heater core (7d), and connected to the engine (1) through the heat storage tank (12).

In the above system, a first pump (4) is provided in the first fluid passage (8) for circulating the engine cooling water from the engine (1) and back to the engine (1) through the heater core (7d) and the bifurcating point (8a), wherein the first pump (1) is provided at a downstream side of the bifurcating point (8a) in the fluid flow, so that a negative pressure is generated in a portion of the first fluid passage (8) between the bifurcating point (8a) and the first pump (4). And a second pump (11) of an electrically operated type is provided in the second fluid passage (10) for circulating the engine cooling water, so that the engine cooling water flows from the heat storage tank (12) to the engine (1).

The waste heat utilizing system further comprises; a check valve (13) provided in the second fluid passage (10) for allowing the engine cooling water to flow only in a direction, which is a direction of the fluid flow caused by a pumping operation of the second pump (11); and a control unit (15) for stopping the operation of the second pump (11) so that the engine cooling water is prevented from flowing into the heat storage tank (12) even in the case that the first pump (11) is operated.

According to a feature of the present invention, a waste heat utilizing system for an automotive vehicle having a water cool internal combustion engine (1) comprises; a heater core (7d) for performing heat exchange between engine cooling water flowing out of the engine (1) and air to be blown into a vehicle passenger room; a first fluid passage (8) for connecting the heater core (7d) with the engine (1) to form a closed fluid circuit, through which the engine cooling water flows from the engine (1) to the heater core (7d); a heat storage tank (12) for storing the engine cooling water and keeping the heat thereof; and a second fluid passage (10) bifurcated from a bifurcating point (8a) of the first fluid passage (8) at a downstream side of the heater core (7d), and connected to the engine (1) through the heat storage tank (12).

In the above system, a first pump (4) is provided in the first fluid passage (8) for circulating the engine cooling water from the engine (1) and back to the engine (1) through the heater core (7d) and the bifurcating point (8a), wherein the first pump (1) is provided at a downstream side of the bifurcating point (8a) in the fluid flow, so that a negative pressure is generated in a portion of the first fluid passage (8) between the bifurcating point (8a) and the first pump (4). And a second pump (11) of an electrically operated type, provided in the second fluid passage (10) for circulating the engine cooling water, so that the engine cooling water flows from the heat storage tank (12) to the engine (1).

The heat storage tank (12) comprises; a main tank body (121); a housing (122, 123) having a fluid flow-in passage (1222) through which the engine cooling water flows into the heat storage tank (12) and a fluid flow-out passage (1223) through which the engine cooling water flows out of the heat storage tank (12); a check valve (13) provided in the fluid flow-out passage (1223) for allowing the engine cooling water to flow only in a direction, which is a direction of the fluid flow caused by a pumping operation of the second pump (11); and an ON-OFF valve (14) provided in the fluid flow-out passage (1223) in parallel with the check valve (13) for opening and closing the fluid flow-out passage (1223) depending on a temperature of the engine cooling water.

According to a further feature of the present invention, a waste heat utilizing system for an automotive vehicle having a water cool internal combustion engine (1) comprises; a main cooling circuit (3) formed by the engine (1), a radiator (2), and a first pump (4), in which engine cooling water is circulated by an operation of the first pump (4); a hot water circuit (8) formed by the engine (1), a heater core (7d), and the first pump (4), so that the engine cooling water is circulated by the operation of the first pump (4), the hot water circuit (8) having a bifurcating point (8a) so that the hot water circuit (8) is divided into a first part (8b) having the heater core (7d) and a second part (8c) having the first pump (4); and a heat storing water circuit (10) connected between the bifurcating point (8a) of the hot water circuit (8) and the engine (1), and having a second pump (11) and a heat storage tank (12), in which the engine cooling water is circulated by an operation of the second pump (11) from and back to the engine (1) through the heater core (7d), the bifurcating point, the second pump (11) and the heat storage tank (12), the engine cooling water being further circulated by the operation of the second pump (11) through the second part (8c) of the hot water circuit (8) and the heat storing water circuit (10).

According to a still further feature of the present invention, a waste heat utilizing system for an automotive vehicle having a water cool internal combustion engine (1) comprises; a main cooling circuit (3) formed by the engine (1), a radiator (2), and a first pump (4), in which engine cooling water is circulated by an operation of the first pump (4); a hot water circuit (8) formed by the engine (1), a heater core (7d), and the first pump (4), so that the engine cooling water is circulated by the operation of the first pump (4), the hot water circuit (8) having a bifurcating point (8a) so that the hot water circuit (8) is divided into a first part (8b) having the heater core (7d) and a second part (8c) having the first pump (4); and a heat storing water circuit (10) connected between the bifurcating point (8a) of the hot water circuit (8) and the engine (1), and having a second pump (11) and a heat storage tank (12), in which the engine cooling water stored in the heat storage tank (12) is circulated by an operation of the second pump (11) from and back to the heat storage tank (12) through the engine (1), the heater core (7d), and the bifurcating point (8a), shortly before the engine operation will be started, so that the engine (1) is warmed up.

In such a system, a part of the engine cooling water is circulated by the operation of the first pump (4) through the main cooling circuit (3) when temperature of the engine cooling water is higher than a predetermined value, and another part of the engine cooling water is circulated at the same time by the operation of the first pump (4) through the first part (8b) of the hot water circuit (8) and the heat storing water circuit (10), so that the high temperature engine cooling water is stored in the heat storage tank (12).

### BRIEF DESCRIPTION OF THE DRAWINGS

The above and other objects, features and advantages of the present invention will become more apparent from the following detailed description made with reference to the accompanying drawing. In the drawing:

FIG. 1 is a schematic system structure for a waste heat utilizing system for an automotive engine according to a first embodiment of the present invention;

FIG. 2 is a table showing various operational modes of the system shown in FIG. 1;

FIG. 3 is the schematic system structure showing an operational mode for a hot water storing operation;

FIG. 4 is the schematic system structure showing an operational mode for a warming-up operation for an automotive engine;

FIG. 5 is the schematic system structure showing an operational mode for a heating operation for a vehicle passenger room after the engine has been warmed up;

FIG. 6 is a schematic system structure for a waste heat utilizing system for an automotive engine according to a second embodiment of the present invention;

FIG. 7 is a table showing various operational modes of the system shown in FIG. 6;

FIG. 8 is a schematic system structure for a waste heat utilizing system for an automotive engine according to a third embodiment of the present invention;

FIG. 9 is a cross sectional view of a hot water storage tank to be applied to the system shown in FIG. 8;

FIG. 10 is an enlarged cross sectional view showing a check valve and an ON-OFF valve of the hot water storage tank shown in FIG. 9;

FIG. 11 is an enlarged cross sectional view showing a portion circled by “XI” in FIG. 10;

FIG. 12 is a schematic view showing the portion shown in FIG. 11, when viewed in a direction of an arrow “XII”; and

FIG. 13 is an enlarged cross sectional view showing the check valve and ON-OFF valve, in which the ON-OFF valve is opened.

### DETAILED DESCRIPTION OF THE PREFERRED EMBODIMENTS

### First Embodiment

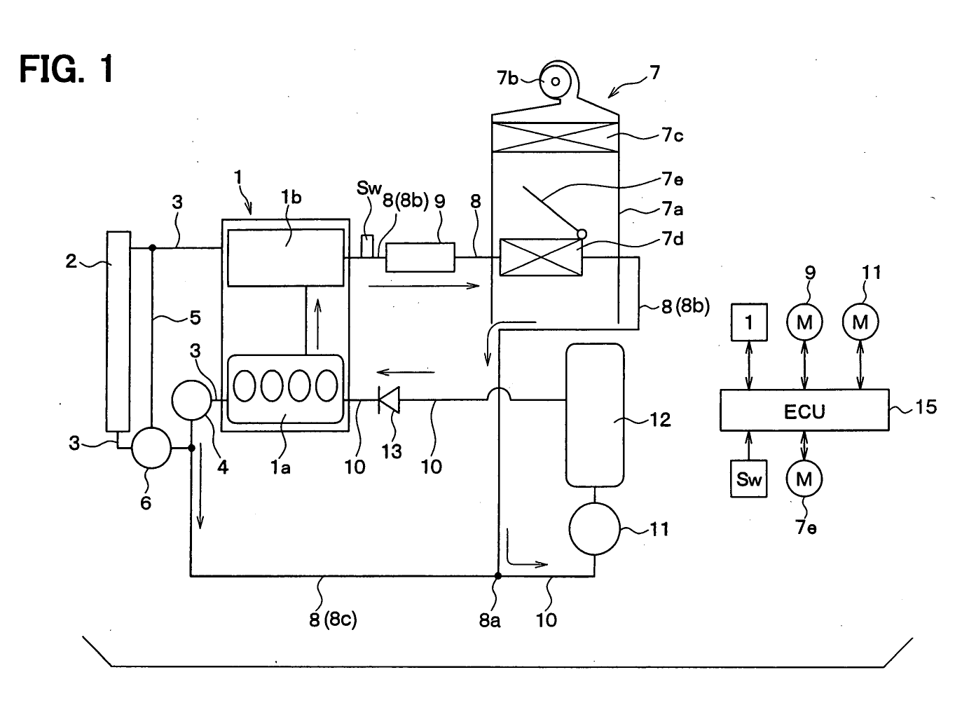

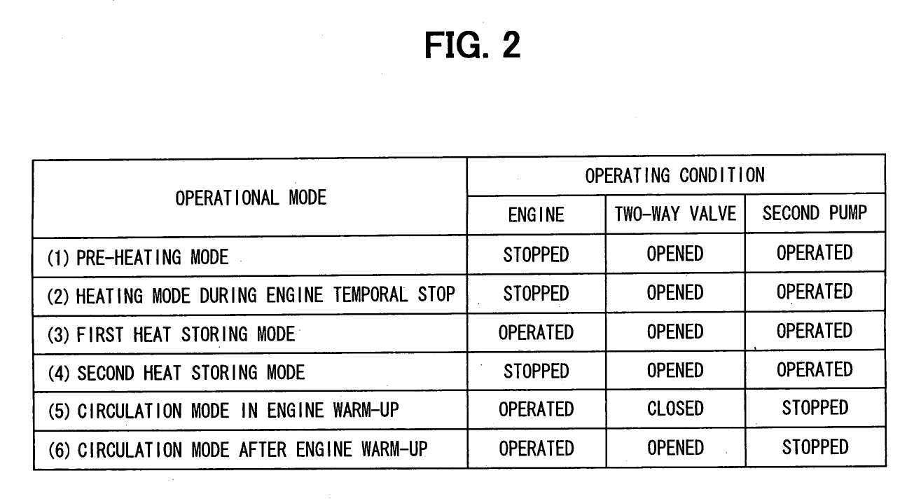

A first embodiment of the present invention will be explained. FIG. 1 shows a schematic system structure for a waste heat utilizing system for an automotive engine according to a first embodiment of the present invention, whereas FIG. 2 is a table showing various operational modes of the system shown in FIG. 1.

In FIG. 1, an internal combustion engine 1 produces a driving power for driving a vehicle, wherein the engine operation is automatically stopped when a certain operational condition for an engine stop is met, whereas the engine operation is automatically re-started when a certain operational condition for an engine re-start is satisfied. For example, the engine operation is stopped when the vehicle temporally stops due to a red traffic lamp, and re-started when a vehicle driver operates the vehicle to move again.

The engine 1 is a water cool type engine, in which a water jacket (not shown) is formed in a cylinder block 1a and a cylinder head 1b for circulating engine cooling water through the engine 1.

High temperature engine cooling water, after having cooled down the engine, is cooled down at a radiator 2. The radiator 2 is, as is well known in the art, a heat exchanger for performing heat exchange between the engine cooling water and the air to cool down the engine cooling water. The engine 1 and the radiator 2 are connected by a main cooling circuit 3, which is formed as a closed fluid circuit between the engine 1 and the radiator 2. A first pump 4 is provided in the main cooling circuit 3, wherein the first pump 4 is operatively connected to the engine 1 and mechanically driven by the driving force of the engine 1, so that the engine cooling water is circulated in the main cooling circuit 3. In the main cooling circuit 3, the engine cooling water is circulated from the cylinder head 1b to the cylinder block 1a through the radiator 2.

A bypass passage 5 is provided in parallel with a portion of the main cooling circuit 3 passing through the radiator 2, so that the engine cooling water may flow through the bypass passage 5 bypassing the radiator 2 when it is opened. A thermostat 6 is provided at an intersecting point of the main cooling circuit 3 and the bypass passage 5, and it switches over the bypass passage to open or close the same. For example, the bypass passage 5 is closed when the temperature of the engine cooling water is higher than 80° C. so that the engine cooling water flows through the radiator 2, whereas the bypass passage 5 is opened when the temperature is lower than 80° C. so that the engine cooling water flows through the bypass passage 5.

An air conditioning apparatus 7 is mounted in the vehicle to perform an air conditioning operation for a vehicle passenger room, wherein the air conditioning apparatus 7 forms a part of the waste heat utilizing system.

The air conditioning apparatus 7 comprises an air conditioning casing 7a, and an air blowing device 7b is arranged at an upstream side of air flow in the casing 7a for blowing the air into the vehicle passenger room.

An evaporator 7c is arranged at a downstream side of the air flow in the air conditioning casing 7a, so that the air from the air blowing device 7b is cooled down. The evaporator 7c is a well known heat exchanger for evaporating refrigerant in a vapor compression type refrigerating cycle.

A heater core 7d is arranged at a downstream side of the evaporator 7c in the air conditioning casing 7a. The heater core 7d heats the air from the air blowing device 7b with heat of the engine cooling water (hot water) for the engine 1.

An air mix door 7e is provided at an air flow-in side of the heater core 7d in the air conditioning casing 7a, for controlling air amount passing through the heater core 7d as well as air amount bypassing the heater core 7d and flowing to a downstream side (to a side of the passenger room), so that the temperature of the air blown into the passenger room is adjusted. The air mix door 7e is operated by an electric motor, and is also referred to as an air flow amount controlling means.

The engine 1 and the heater core 7d are connected with each other by a hot water circuit 8 to form a closed fluid circuit. More specifically, one end of the hot water circuit 8 is connected to the water jacket of the cylinder head 1b, whereas the other end thereof is linked with the main cooling circuit 3 at an intersecting point between the first pump 4 and the thermostat 6, and connected to the water jacket of the cylinder block 1a through the first pump 4.

A two-way valve 9 is provided between the water jacket of the cylinder head 1b and the heater core 7d in the hot water circuit 8, wherein the two-way valve 9 is operated by an electric motor to open or close the hot water circuit 8. The engine cooling water (hot water) flows from the cylinder head 1b to the heater core 7d through the two-way valve 9. The hot water circuit 8 is also referred to as a first fluid circuit.

A water temperature sensor Sw is provided between the water jacket of the cylinder head 1b and the two-way valve 9 in the hot water circuit 8, for detecting water temperature of the engine cooling water. The sensor Sw outputs an electrical signal in accordance with the detected water temperature.

A heat storing water circuit 10 is bifurcated from the hot water circuit 8, namely bifurcated from a bifurcating point 8a, which is positioned at a downstream side of the heater core 7d of the fluid flow of the engine cooling water in the hot water circuit 8, and connected to the water jacket of the cylinder block 1a. The heat storing water circuit 10 is also referred to as a second fluid circuit.

The hot water circuit 8 is divided into a first part 8b in which the two-way valve 9 and the heater core 7d are arranged, and a second part 8c in which the first pump 4 is arranged.

A second pump 11, which is operated by an electric motor, is provided in the heat storing water circuit 10 in order that the engine cooling water (hot water) flowing from the hot water circuit 8 is circulated to the water jacket of the cylinder block 1a through the heat storing water circuit 10.

A heat storage tank 12 is provided at a downstream side of the second pump 11 in the heat storing water circuit 10, for storing and keeping the temperature of the engine cooling water (hot water). A check valve 13 is provided at a downstream side of the heat storage tank 12 in the heat storing water circuit 10, so that the engine cooling water is allowed to flow only in the direction from the second pump 11 to the heat storage tank 12.

An electronic control unit 15 comprises a well known microcomputer having CPU, ROM, RAM and soon and performs calculation process in accordance with programs memorized in the microcomputer. The output signal from the water temperature sensor Sw, an operation signal from an engine key switch (not shown), and other various signals for determining an engine stop condition and an engine re-start condition for the engine 1 are inputted to the electronic control unit 15, so that the electronic control unit 15 controls operations of the engine 1, the air mix door 7e, the two-way valve 9, the second pump 11 and so on in accordance with the above inputted signals.

The waste heat utilizing system according to the embodiment has the following six (6) operational modes, as shown in FIG. 2. An operation of the waste heat utilizing system in the respective operational modes will be explained.

(1: Pre-Heating Mode)

An operation of a pre-heating mode is carried out shortly before the engine 1 will be started. When the key switch is operated to an engine starting position, and the temperature of the engine cooling water is lower than a first predetermined temperature, the electronic control unit 15 (hereinafter, also referred to as ECU) opens the two-way valve 9 to open the hot water circuit 8 and operates the second pump 11 for a certain time period.

The engine cooling water is then circulated from the heat storage tank 12 and back to the heat storage tank 12, through the check valve 13, the cylinder block 1a, the cylinder head 1b, the two-way valve 9, the heater core 7d, and the second pump 11, as indicated by arrows in FIG. 1. In addition, the engine cooling water is circulated from the heat storage tank 12 and back to the heat storage tank 12, through the check valve 13, the cylinder block 1a, the first pump 4, and the second pump 11. The engine 1 is thereby heated by the hot water stored in the heat storage tank 12. As a result, the warming-up operation of the engine 1 is facilitated and thereby the fuel consumption ratio as well as emission of harmful exhaust gas is improved. According to the embodiment, the engine 1 is started after the pre-heating operation has ended.

(2: Heating Mode During the Engine Temporal Stop)

A heating mode for the vehicle passenger room is carried out when the engine operation is automatically stopped, as a result that an engine temporal stop condition is met, for example, when the vehicle stops in front of a traffic lamp. Namely, when the engine temporal stop condition is met and the engine operation is stopped, and when the temperature of the engine cooling water is higher than a second predetermined temperature, the ECU 15 opens the two-way valve 9 to open the hot water circuit 8 and operates the second pump 11 to perform the heating operation during the engine temporal stop.

The engine cooling water (hot water) is circulated, as indicated by the arrows in FIG. 1, namely in the same manner to the pre-heating mode, so that the engine cooling water heated by after heat of the engine 1 flows into the heater core 7d. Accordingly, the heating operation for the vehicle passenger room can be carried out even when the engine operation is stopped after the engine 1 has been warmed up.

(3: First Heat Storing Mode)

A first heat storing mode is performed after the engine 1 has been warmed up in order to store a high temperature water in the heat storage tank 12 in anticipation of the pre-heating operation in the next engine start. Namely, when the engine 1 is in its operation and the temperature of the engine cooling water is higher than a third predetermined temperature, the ECU 15 opens the two-way valve 9 to open the hot water circuit 8, drives the air mix door 7e to prevent the air from passing through the heater core 7d, and starts the operation of the second pump 11 to start the first heat storing operation.

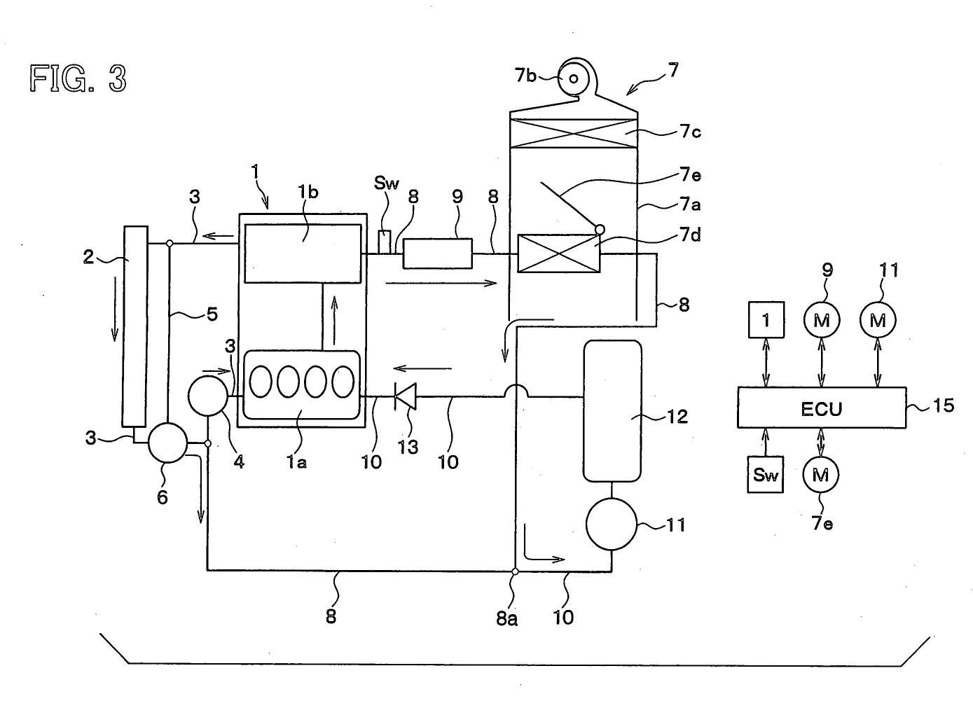

The engine cooling water is then circulated from the heat storage tank 12 and back to the heat storage tank 12, through the check valve 13, the cylinder block 1a, the cylinder head 1b, the two-way valve 9, the heater core 7d, and the second pump 11, as indicated by arrows in FIG. 3. At the same time, a part of the engine cooling water circulating in the main cooling circuit 3 is bifurcated at the downstream side of the thermostat 6 and flows into the heat storage tank 12 through the second pump 11.

Accordingly, the engine cooling water of the low temperature, which has been stored in the heat storage tank 12 in the previous pre-heating operation, will be replaced with the high temperature engine cooling water, so that the hot water is stored in the heat storage tank 12.

Since the air mix door 7e prevents the air from passing through the heater core 7d, the heat exchange between the air and the high temperature engine cooling water is suppressed so that the radiation of the heat in the heater core 7d is minimized. As a result, the high temperature engine cooling water is effectively stored in the heat storage tank 12.

When the engine cooling water of the low temperature in the heat storage tank 12 is circulated to reach at a position of the water temperature sensor Sw, the detected temperature of the engine cooling water is temporarily decreased to become lower than the third predetermined temperature for a short period. It can be presumed that the replacement of the low temperature water with the high temperature water in the heat storage tank 12 has been completed, when the engine cooling water of the low temperature in the heat storage tank 12 has reached at the position of the water temperature sensor Sw.

The ECU 15, therefore, stops the operation of the second pump 11 to stop the first heat storing operation, when the detected temperature of the engine cooling water becomes lower than the third predetermined temperature during the operation of the first heat storing mode.

(4: Second Heat Storing Mode)

A second heat storing mode is performed when the engine operation is stopped by the key operation of the vehicle driver, wherein the temperature of the engine cooling water has not been increased to become higher than the third predetermined temperature and thereby the first heat storing mode has not been performed.

Namely, when the engine operation is stopped by the vehicle driver before the temperature of the engine cooling water has been increased to become higher than the third predetermined temperature, the ECU 15 opens the two-way valve 9 to open the hot water circuit 8 and operates the second pump 11, to perform the second heat storing operation for a certain time period.

The engine cooling water is circulated, as indicated by the arrows in FIG. 1, namely in the same manner to the pre-heating mode, the engine cooling water of the low temperature, which has been stored in the heat storage tank 12 in the previous pre-heating operation, will be replaced with the engine cooling water heated by the engine operation.

(5: Circulation Mode in Engine Warm-Up)

The circulation mode is performed during a period in which the engine 1 is being warmed up. Namely, when the engine 1 is in its operation but the temperature of the engine cooling water is lower than the third predetermined temperature, the ECU 15 closes the two-way valve 9 to close the hot water circuit 8 and stops the operation of the second pump 11, to perform the engine warm up operation.

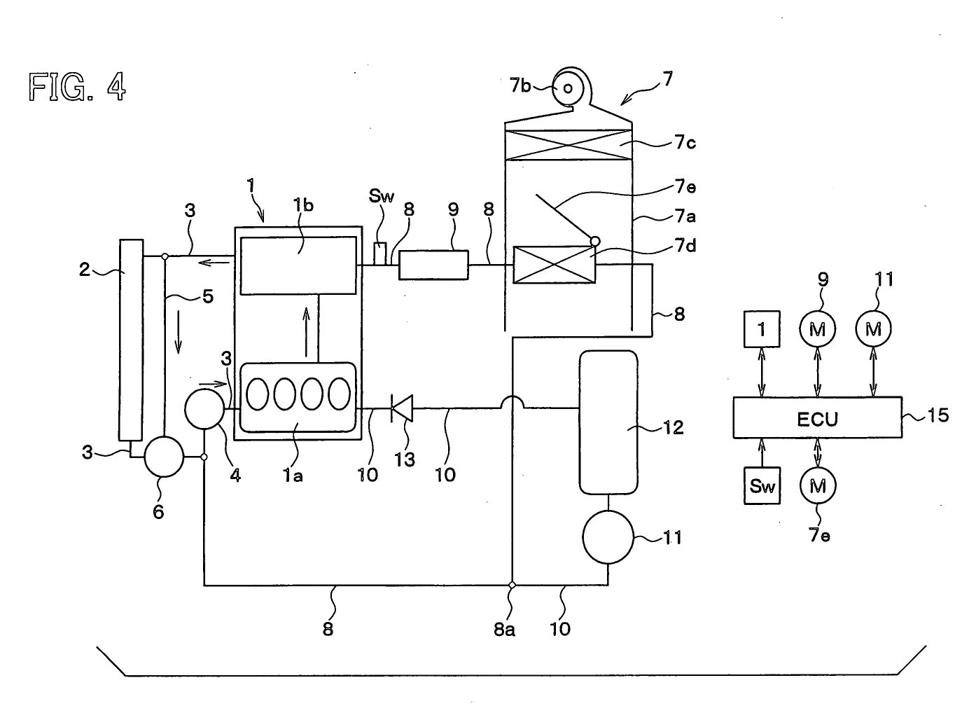

The engine cooling water is therefore circulated, as indicated by arrows in FIG. 4, from the first pump 4 and back to the first pump 4, through the cylinder block 1a, the cylinder head 1b, the bypass passage 5 and the thermostat 6.

Since the hot water circuit 8 is closed by the two-way valve 9 during the above operation, to prevent the engine cooling water from flowing through the heater core 7d, the heat radiation at the heater core 7d is prevented to facilitate the engine warming up operation.

In the above engine warm-up operation, a negative pressure is generated, by the pumping operation of the first pump 4, in the hot water circuit 8, which is in the downstream side from an intersecting point 10a between the hot water circuit 8 and the heat storing water circuit 10. The fluid flow of the engine cooling water from the hot water circuit 8 to the heat storing water circuit 10 is suppressed by such negative pressure, and the fluid flow of the engine cooling water from the engine 1 to the heat storing water circuit 10 is also prevented by the check valve 13. The heat radiation in the heat storage tank 12 is thereby prevented to facilitate the engine warming up operation.

(6: Circulation Mode after Engine Warm-Up)

The circulation mode is performed after the warm-up operation for the engine 1 is completed. Namely, when the engine 1 is in its operation and the temperature of the engine cooling water is higher than the third predetermined temperature, the ECU 15 opens the two-way valve 9 to open the hot water circuit 8 but stops the operation of the second pump 11, to perform the circulation mode of the engine cooling water after the engine warm-up.

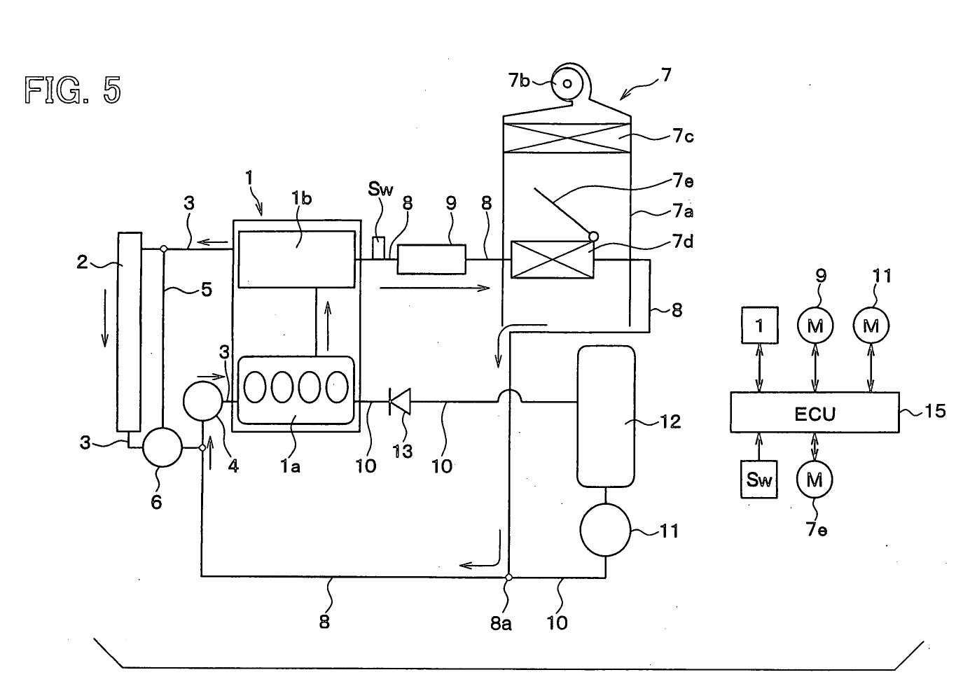

The engine cooling water is therefore circulated in the main cooling circuit 3, as indicated by arrows in FIG. 5, and furthermore circulated from the cylinder head 1b and back to the cylinder head 1b, through the two-way valve 9, the heater core 7d, the first pump 4, and the cylinder block 1a. As above, since the high temperature engine cooling water flows through the heater core 7d, the heating operation for the vehicle passenger room can be performed.

### Second Embodiment

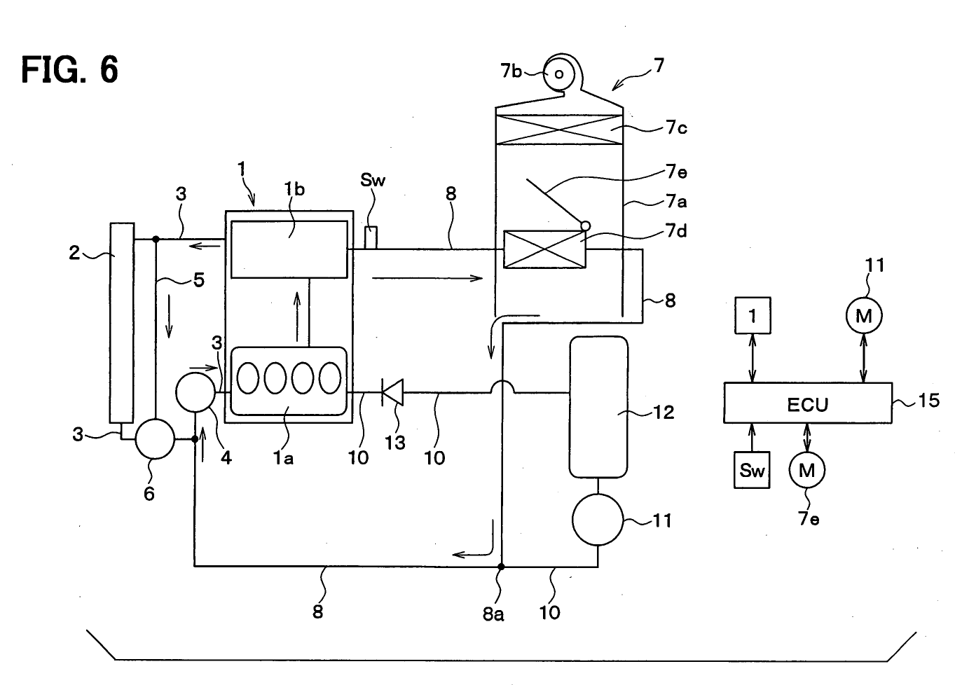

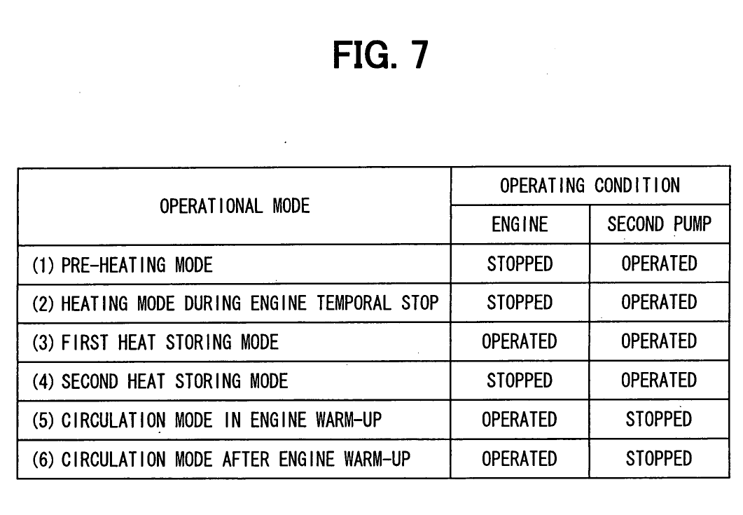

A second embodiment of the present invention will be explained. FIG. 6 shows a schematic system structure for a waste heat utilizing system for an automotive engine according to a second embodiment of the present invention, whereas FIG. 7 is a table showing various operational modes of the system shown in FIG. 6.

In the second embodiment, the two-way valve 9 of the first embodiment is eliminated. As shown in FIG. 7, however, the operational modes of the second embodiment (the operational conditions of the engine 1 and the second pump 11) are the same to those of the first embodiment (FIG. 2).

The fluid flow of the engine cooling water in the circulation mode in the engine warm-up operation is different from that of the first embodiment, because the two-way valve 9 of the first embodiment is eliminated in this second embodiment.

FIG. 6 shows the fluid flow of the engine cooling water in the circulation mode of the engine warm-up operation. The engine cooling water is circulated from the first pump 4 and back to the first pump 4, through the cylinder block 1a, the cylinder head 1b, the bypass passage 5, and the thermostat 6, and also circulated from the cylinder head 1b and back to the cylinder head 1b, through the heater core 7d, the first pump 4, and the cylinder block 1a.

In the above operational mode, the ECU 15 drives the air mix door 7e to move to such a position, at which the air mix door 7e prevents the air from passing through the heater core 7d. At such position of the air mix door 7e, the heat exchange between the air and the engine cooling water is suppressed, namely the heat radiation at the heater core 7d is prevented to facilitate the engine warming up operation.

(Modifications)

The present invention in the above embodiments is applied to the automotive vehicle, in which the engine 1 is automatically stopped when the engine stop condition is met, whereas the engine 1 is automatically re-started when the engine re-start condition is met. The present invention, however, can be also applied to a hybrid vehicle having the internal combustion engine 1 and an electric motor for generating driving forces for the vehicle running.

In the above first embodiment, the air is prevented by the air mix door 7e from passing through the heater core 7d in the first heat storing mode, so that the heat exchange at the heater core 7d between the air and the engine cooling water is suppressed. However, the fluid flow of the engine cooling water to the heater core 7d may be stopped by closing the hot water circuit 8 by the two-way valve 9, so that the heat radiation at the heater core 7d is minimized to facilitate the engine warming up operation.

### Third Embodiment

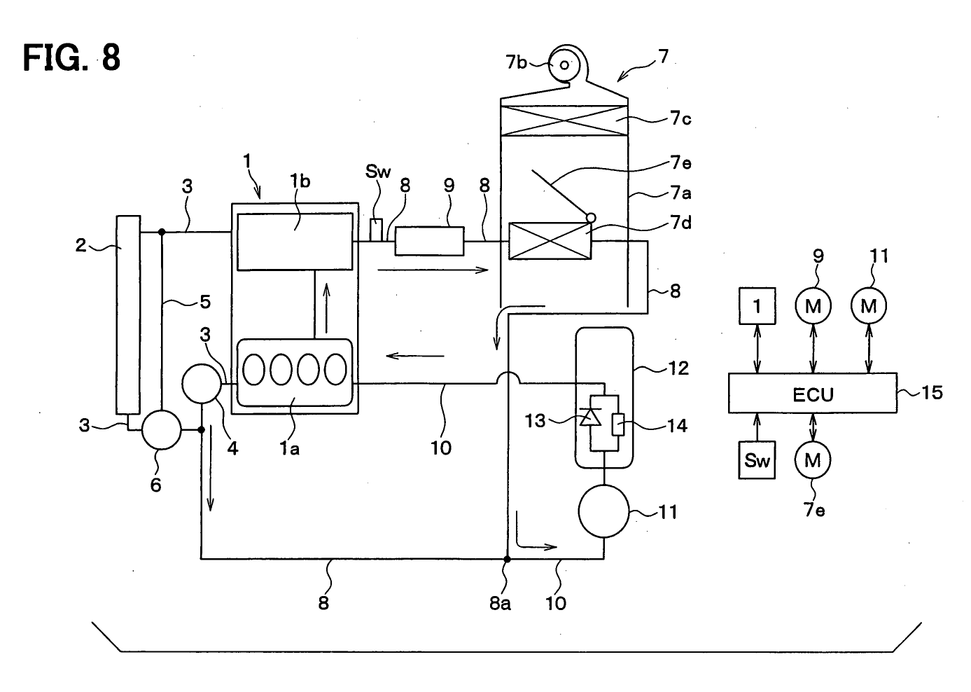

A third embodiment of the present invention will be explained with reference to FIGS. 8 to 13. A system structure of the third embodiment differs from the first embodiment, in that the check valve 13 for allowing the engine cooling water to flow only in one direction (the direction of the pumped out water by the second pump 11) is provided in the heat storage tank 12, and an ON-OFF valve 14 is provided in parallel with the check valve 13 for opening and closing a fluid passage in the heat storage tank 12 in accordance with the temperature of the engine cooling water.

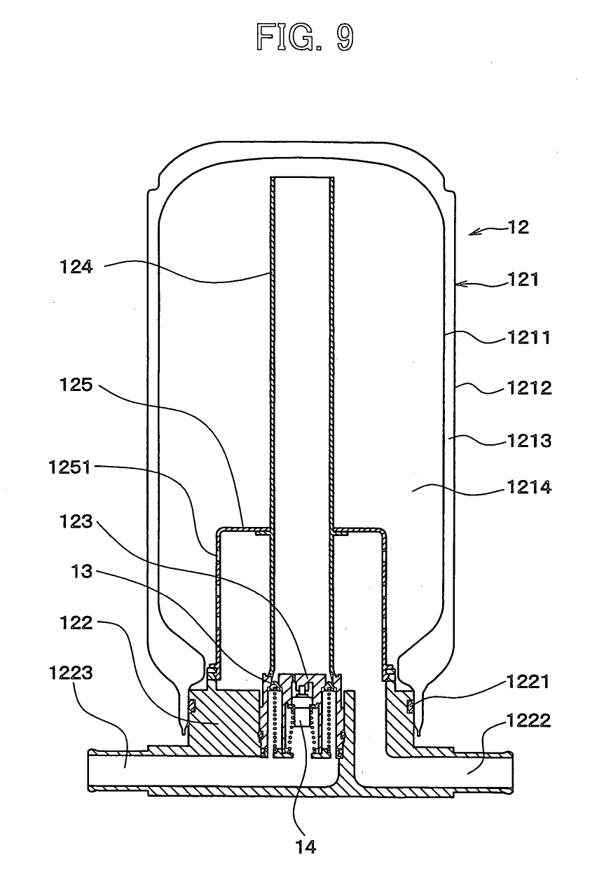

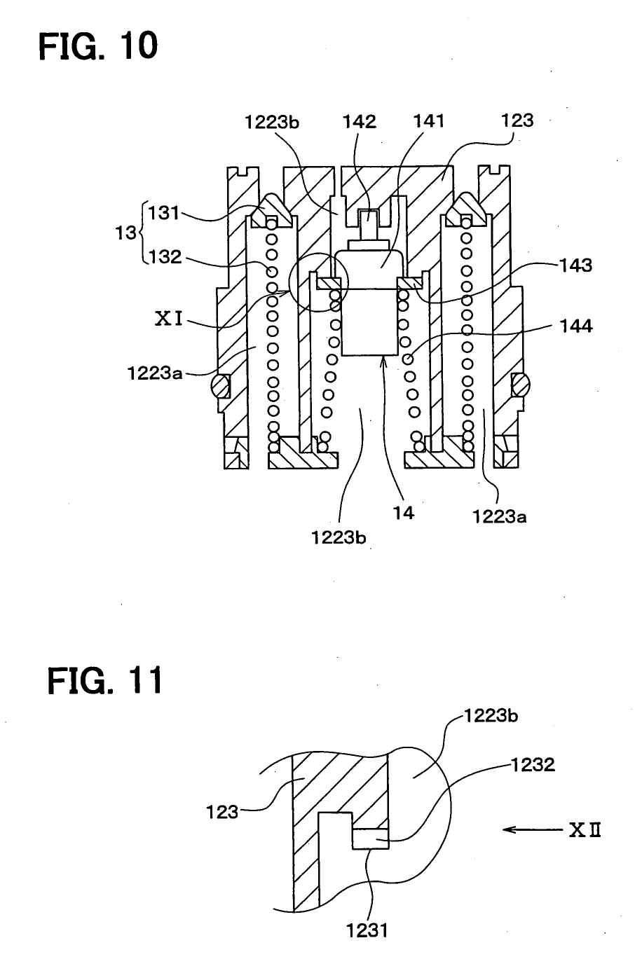

FIG. 9 is a cross sectional view showing a structure of the heat storage tank 12, and FIG. 10 is an enlarged cross sectional view showing the check valve 13 and the ON-OFF valve 14.

As shown in FIG. 9, the heat storage tank 12 has a main tank body 121, which is made of such material having a high corrosion resistive characteristic, such as stainless steel. The main tank body 121 comprises an inside tank member 1211 and an outside tank member 1212, each of which is formed into a cylindrical shape having a closed end at its top portion. A heat insulating space 1213 of almost vacuum is formed between the inside and outside tank members 1211 and 1212. A water storage portion 1214 is formed in the inside space of the inside tank member 1211.

A first housing member 122 made of resin is inserted into an opening portion of the main tank body 121 to close the opening portion. An O-ring 1221 is arranged between the inside tank member 1211 and the first housing member 122 to seal gap between the inside tank member 1211 and the first housing member 122.

A second housing member 123 is inserted into the first housing member 122 on a side of the water storage portion 1214. A flow-in passage 1222 is formed in the first housing member 122, for communicating the heat storing water circuit 10 on the side of the second pump 11 (FIG. 8) with the water storage portion 1214. A flow-out passage 1223 is formed in the first and second housing members 122 and 123, for communicating the heat storing water circuit 10 on the side of the cylinder block 1a (FIG. 8) with the water storage portion 1214.

A pipe member 124 is fixed to the second housing member 123 on a side of the water storage portion 1214. The flow-out passage 1223 is communicated with the water storage portion 1214 through the pipe member 124.

A partitioning plate member 125, which is formed into a cup shape, is fixed to the first housing member 122 on the side of the water storage portion 1214, wherein the partitioning plate member 125 surrounds the flow-in passage 1222 on the side of the water storage portion 1214. Multiple flow-out openings 1251 are formed in the partitioning plate member 125, so that the engine cooling water having flown into the space surrounded by the cup shaped portioning plate member 125 via the flow-in passage 1222 may flow out to the water storage portion 1214 through the multiple flow-out openings 1251.

As shown in FIGS. 9 and 10, the flow-out passage 1223 is divided into two (first and second) flow-out passage portions 1223a and 1223b in the second housing member 123, wherein the first and second passage portions 1223a and 1223b are arranged in parallel to each other. More specifically, the first and second passage portions 1223a and 1223b are coaxially arranged, so that the second flow-out passage portion 1223b of a cylindrical shape is arranged in the inside of the first flow-out passage portion 1223a of a cylindrical shape.

The check valve 13 is arranged in the first flow-out passage portion 1223a. The check valve 13 comprises a valve body 131 of a doughnut shape for opening and closing the first flow-out passage portion 1223a, and a coil spring 132 of a cylindrical shape for urging the valve body 131 in a valve closing direction.

The ON-OFF valve 14 is arranged in the second flow-out passage portion 1223b. The ON-OFF valve 14 comprises a temperature sensing portion 141 having thermo-wax, volume of which increases in accordance with the temperature increase and then largely increases when the temperature exceeds a threshold value. The ON-OFF valve 14 further comprises a rod 142 fixed to the second housing member 123 and movably inserted into the temperature sensing portion 141, so that the rod 142 moves into or moves out of the temperature sensing portion 141 depending on the volume change of the thermo-wax. Namely, since the one end of the rod 142 is fixed to the second housing member 123, the temperature sensing portion 141 is driven to move depending on the volume change of the thermo-wax. A valve body 143 is fixed to an outer peripheral portion of the temperature sensing portion 141 for opening and closing the second flow-out passage portion 1223b. A coil spring 144 of a conical shape is arranged for urging the valve body 143 in a valve closing direction.

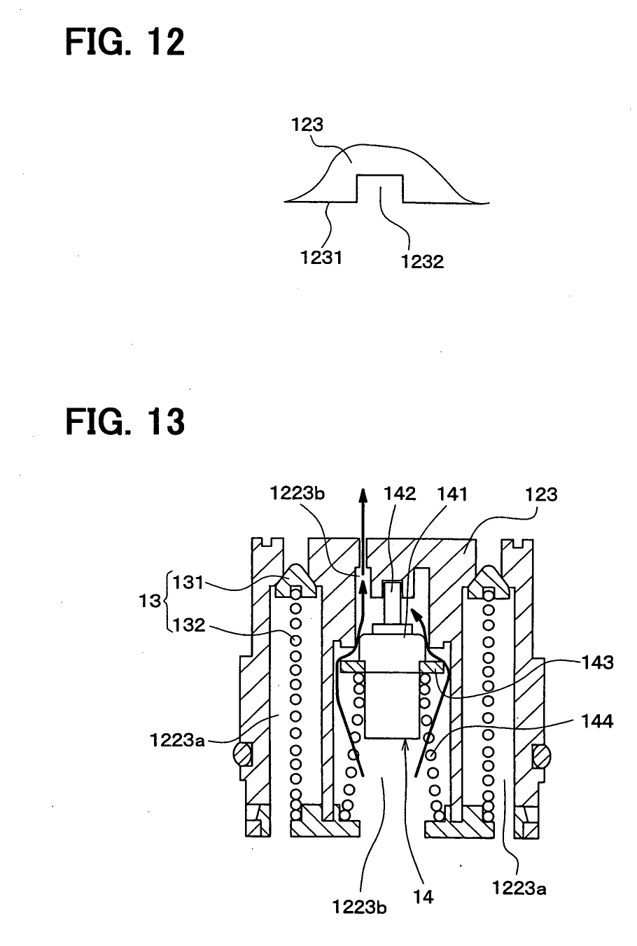

FIG. 11 is an enlarged cross sectional view of a portion “XI” of the second housing member 123 in FIG. 10, and FIG. 12 is a side view of the same portion “XI” when viewed in a direction “XII” in FIG. 11. As shown in FIGS. 11 and 12, a communication passage 1232 of a groove shape is formed at a valve seat 1231, at which and from which the valve boy 143 of the ON-OFF valve 14 in the second housing member 123 is seated and/or separated, so that the upstream and downstream sides of the second flow-out passage portion 1223b of the ON-OFF valve 14 are always communicated with each other.

An operation of the waste heat utilizing system according to the embodiment will be explained.

An operation of the pre-heating mode is carried out shortly before the engine 1 is started. Namely when the key switch is operated to the engine starting position, and the temperature of the engine cooling water is lower than the (first) predetermined temperature, the ECU 15 opens the two-way valve 9 to open the hot water circuit 8 and operates the second pump 11 for a certain time period, as in the same manner to the first embodiment.

In this pre-heating operation, the check valve 13 is opened by the discharge pressure of the second pump 11, and the engine cooling water is then circulated from the heat storage tank 12 and back to the heat storage tank 12, through the cylinder block 1a, the cylinder head 1b, the two-way valve 9, the heater core 7d, and the second pump 11, as indicated by arrows in FIG. 8. In addition, the engine cooling water is circulated from the heat storage tank 12 and back to the heat storage tank 12, through the cylinder block 1a, the first pump 4, and the second pump 11. The engine 1 is thereby heated by the hot water stored in the heat storage tank 12. As a result, the warming-up operation of the engine 1 is facilitated and thereby the fuel consumption ratio as well as emission of harmful exhaust gas is improved. According to the embodiment, the engine 1 is started after the pre-heating operation has ended.

During the warm-up operation of the engine 1, the first pump 4 is operated, whereas the operation of the second pump 11 is stopped. The engine cooling water is therefore circulated from the first pump 4 and back to the first pump 4, through the cylinder block 1a, the cylinder head 1b, the bypass passage 5 and the thermostat 6.

In the heat storage tank 12, since the discharge pressure of the first pump 4 is applied to the check valve 13 through the cylinder block 1a and the heat storing water circuit 10, the check valve 13 is kept closed. And since the temperature of the engine cooling water is low, the ON-OFF valve 14 is also closed. However, a small amount of the engine cooling water flows from the second flow-out passage portion 1223b to the water storage portion 1214 through the communication passage 1232 of the second housing member 123, so that the thermo-wax of the temperature sensing portion 141 may detect the temperature of the engine cooling water. The small amount of the engine cooling water flowing through the communication passage 1232 is designed to be such an amount, which may not adversely affect the heating operation at the heater core 7d.

When the temperature of the engine cooling water reaches the predetermined threshold value, as the warming-up operation proceeded, the second flow-out passage portion 1223b is opened by the ON-OFF valve 14, because the temperature sensing portion 141 as well as the valve body 143 is separated from the valve seat 1231 of the second housing member 123 by the expansion of the thermo-wax, as shown in FIG. 13.

As a result, a part of the high temperature engine cooling water pumped out from the first pump 4 flows through the cylinder block 1a, the heat storing water circuit 10, the flow-out passage 1223, the second flow-out passage portion 1223b and into the water storage portion 1214. Accordingly, the engine cooling water of the low temperature, which has been stored in the heat storage tank 12 in the previous pre-heating operation, will be replaced with the high temperature engine cooling water, so that the hot water is stored in the heat storage tank 12.

As above, the high temperature engine cooling water can be stored in the heat storage tank 12 without operating the second pump 11. This means that the operating rate of the second pump 11 can be reduced, and thereby the consumption of the electric power is reduced.

In other words, the second pump 11 is operated only when the engine 1 is warmed up by use of the hot water stored in the heat storage tank 12 (i.e. the pre-heating mode). Accordingly, when compared with the first embodiment, the consumption of the electric power is reduced in this embodiment.

Furthermore, the check valve 13 and the ON-OFF valve 14 are provided within the heat storage tank 12, the waste heat utilizing system of this embodiment requires a smaller space for mounting.

Furthermore, since it is not necessary to mount the check valve 13 in the heat storing water circuit 10, it is not necessary to use screws, hose cramps and so on. This means that a number of assembling processes can be reduced.

(Modifications)

The mechanical type ON-OFF valve 14 of the thermo-wax type is used in the above embodiment. However, an electrically driven ON-OFF valve can be used, so that it is controlled by the ECU 15.

The check valve 13 and the ON-OFF valve 14 are not necessarily formed as an integral unit. In an arrangement, in which the ON-OFF valve 14 is opened or closed in accordance with the temperature of the engine cooling water at an outlet portion of the engine, and the engine cooling water bypasses the check valve 13, the operating rate of the second pump 11 can be reduced and the consumption of the electric power can be saved, whether or not the ON-OFF valve 14 and the check valve 13 are integrally formed.

What is claimed is:

1. A waste heat utilizing system for an automotive vehicle having a water cool internal combustion engine comprising:
a heater core for performing heat exchange between engine cooling water flowing out of the engine and air to be blown into a vehicle passenger room;
a first fluid passage for connecting the heater core with the engine to form a closed fluid circuit, through which the engine cooling water flows from the engine to the heater core;
a heat storage tank for storing the engine cooling water and keeping the heat thereof;
a second fluid passage bifurcated from a bifurcating point of the first fluid passage at a downstream side of the heater core, and connected to the engine through the heat storage tank;
a first pump provided in the first fluid passage for circulating the engine cooling water from the engine and back to the engine through the heater core and the bifurcating point, wherein the first pump is provided at a downstream side of the bifurcating point in the fluid flow, so that a negative pressure is generated in a portion of the first fluid passage between the bifurcating point and the first pump;
a second pump of an electrically operated type, provided in the second fluid passage for circulating the engine cooling water, so that the engine cooling water flows from the heat storage tank to the engine;
a check valve provided in the second fluid passage for allowing the engine cooling water to flow only in a direction, which is a direction of the fluid flow caused by a pumping operation of the second pump; and
a control unit for stopping the operation of the second pump so that the engine cooling water is prevented from flowing into the heat storage tank even in the case that the first pump is operated.

2. A waste heat utilizing system according to claim 1, wherein
the control unit operates the second pump after the engine operation is stopped, so that the high temperature engine cooling water is continuously supplied to the heater core to perform a heating operation for the vehicle passenger room.

3. A waste heat utilizing system according to claim 1, wherein
the control unit operates the second pump before starting the engine operation to supply the high temperature engine cooling water stored in the heat storage tank to the engine.

4. A waste heat utilizing system according to claim 1, further comprising:
a two-way valve provided in the first fluid passage at an upstream side of the bifurcating point for opening and closing the first fluid passage.

5. A waste heat utilizing system according to claim 1, further comprising:
an air flow amount controlling means for controlling an air amount passing through the heater core.

6. A waste heat utilizing system according to claim 1, wherein
the engine operation is automatically stopped when a certain engine stop condition is satisfied, whereas the engine operation is automatically re-started in the case that a certain engine re-start condition is satisfied.

7. A waste heat utilizing system for an automotive vehicle having a water cool internal combustion engine comprising:
a heater core for performing heat exchange between engine cooling water flowing out of the engine and air to be blown into a vehicle passenger room;
a first fluid passage for connecting the heater core with the engine to form a closed fluid circuit, through which the engine cooling water flows from the engine to the heater core;
a heat storage tank for storing the engine cooling water and keeping the heat thereof;
a second fluid passage bifurcated from a bifurcating point of the first fluid passage at a downstream side of the heater core, and connected to the engine through the heat storage tank;
a first pump provided in the first fluid passage for circulating the engine cooling water from the engine and back to the engine through the heater core and the bifurcating point, wherein the first pump is provided at a downstream side of the bifurcating point in the fluid flow, so that a negative pressure is generated in a portion of the first fluid passage between the bifurcating point and the first pump; and
a second pump of an electrically operated type, provided in the second fluid passage for circulating the engine cooling water, so that the engine cooling water flows from the heat storage tank to the engine;
wherein the heat storage tank comprises;
a main tank body;
a housing having a fluid flow-in passage through which the engine cooling water flows into the heat storage tank and a fluid flow-out passage through which the engine cooling water flows out of the heat storage tank;
a check valve provided in the fluid flow-out passage for allowing the engine cooling water to flow only in a direction, which is a direction of the fluid flow caused by a pumping operation of the second pump; and
an ON-OFF valve provided in the fluid flow-out passage in parallel with the check valve for opening and closing the fluid flow-out passage depending on a temperature of the engine cooling water.

8. A waste heat utilizing system according to claim 7, wherein
the check valve comprises a doughnut-shaped valve body, and
the ON-OFF valve is coaxially arranged with the valve body within an inside of the valve body.

9. A waste heat utilizing system according to claim 7, wherein
the ON-OFF valve comprises a thermo-wax, volume of which is changed depending on the temperature of the engine cooling water, so that the ON-OFF valve opens and closes the fluid flow-out passage in accordance with such volume change, and
the housing comprises a communication passage for always communicating upstream and downstream sides of the ON-OFF valve with each other.

10. A waste heat utilizing system for an automotive vehicle having a water cool internal combustion engine comprising:
a main cooling circuit formed by the engine, a radiator, and a first pump, in which engine cooling water is circulated by an operation of the first pump;
a hot water circuit formed by the engine, a heater core, and the first pump, so that the engine cooling water is circulated by the operation of the first pump, the hot water circuit having a bifurcating point so that the hot water circuit is divided into a first part having the heater core and a second part having the first pump; and
a heat storing water circuit connected between the bifurcating point of the hot water circuit and the engine, and having a second pump and a heat storage tank, in which the engine cooling water is circulated by an operation of the second pump from and back to the engine through the heater core, the bifurcating point, the second pump and the heat storage tank, the engine cooling water being further circulated by the operation of the second pump through the second part of the hot water circuit and the heat storing water circuit.

11. A waste heat utilizing system according to claim 10, wherein
the engine cooling water is circulated by the operation of the second pump through the first part of the hot water circuit and the heat storing water circuit when temperature of the engine cooling water is higher than a predetermined value, so that the high temperature engine cooling water is stored in the heat storage tank.

12. A waste heat utilizing system according to claim 10, wherein
the engine cooling water is circulated by the operation of the second pump through the first part of the hot water circuit and the heat storing water circuit, when temperature of the engine cooling water is high even after an engine operation is stopped, so that the high temperature engine cooling water is stored in the heat storage tank.

13. A waste heat utilizing system according to claim 10, wherein
the engine cooling water stored in the heat storage tank is circulated, by the operation of the second pump shortly before the engine operation will be started, through the heat storing water circuit and the first part of the hot water circuit, so that the engine is warmed up.

14. A waste heat utilizing system according to claim 10, wherein
a check valve is provided in the heat storing water circuit for allowing the engine cooling water to flow only in a direction, which is a direction of the fluid flow caused by the operation of the second pump,
a bypass passage is provided in the main cooling circuit, so that the engine cooling water bypasses the radiator when the bypass passage is opened, and
the engine cooling water is circulated by the operation of the first pump in the main cooling circuit through the bypass passage, when the temperature of the engine cooling water is low, so that an engine warm-up operation is performed,
wherein a negative pressure is generated in the second part of the hot water circuit so that the engine cooling water is prevented from flowing into the heat storage tank during such engine warm-up operation.

15. A waste heat utilizing system for an automotive vehicle having a water cool internal combustion engine comprising:
a main cooling circuit formed by the engine, a radiator, and a first pump, in which engine cooling water is circulated by an operation of the first pump;
a hot water circuit formed by the engine, a heater core, and the first pump, so that the engine cooling water is circulated by the operation of the first pump, the hot water circuit having a bifurcating point so that the hot water circuit is divided into a first part having the heater core and a second part having the first pump; and
a heat storing water circuit connected between the bifurcating point of the hot water circuit and the engine, and having a second pump and a heat storage tank, in which the engine cooling water stored in the heat storage tank is circulated by an operation of the second pump from and back to the heat storage tank through the engine, the heater core, and the bifurcating point, shortly before the engine operation will be started, so that the engine is warmed up,
wherein a part of the engine cooling water is circulated by the operation of the first pump through the main cooling circuit when temperature of the engine cooling water is higher than a predetermined value, and
another part of the engine cooling water is circulated at the same time by the operation of the first pump through the first part of the hot water circuit and the heat storing water circuit, so that the high temperature engine cooling water is stored in the heat storage tank.

16. A waste heat utilizing system according to claim 15, wherein
a check valve is provided in the heat storing water circuit for allowing the engine cooling water to flow only in a direction, which is a direction of the fluid flow caused by the pumping operation of the second pump; and
an ON-OFF valve is provided in the heat storing water circuit in parallel with the check valve for opening and closing the heat storing water circuit depending on the temperature of the engine cooling water.
